(19) United States
(12) Patent Application Publication
(10) Pub. No.: US 2016/0297658 A1
(43) Pub. Date: Oct. 13, 2016

(54) Method and Apparatus for Closing Lids

(71) Applicant: Steven M. Falcaro, Sugar Hill, GA (US)

(72) Inventor: Steven M. Falcaro, Sugar Hill, GA (US)

(21) Appl. No.: 15/084,699

(22) Filed: Mar. 30, 2016

Related U.S. Application Data
(60) Provisional application No. 62/178,292, filed on Apr. 7, 2015.

(51) Int. Cl. B67B 6/00

(52) U.S. Cl. CPC B67B 6/00

(57) ABSTRACT

A paint lid closer can be used to facilitate the closing of paint lids. A slidable impact grip can be used to confer pressure to a base plate, wherein the base plate can then transition the pressure to a paint can lid during use. The pressure applied via the base plate can then cause the paint lid to seal, thereby eliminating any spills or splattering of paint during the lid closing process.

### CROSS-REFERENCE TO RELATED APPLICATIONS

The present application claims the benefit of priority to U.S. provisional patent application No. 62/178,292, filed Apr. 7, 2015, and titled “Paint Can Lid Closer” the entirety of which is hereby incorporated herein by reference.

### TECHNICAL FIELD

This disclosure relates generally to closing lids of cans. More specifically, this disclosure relates to the use of an apparatus for securely closing the lids of paint cans.

### BACKGROUND

For metal cans, a large diameter nail or punch can be used to make drain holes in the lip of the can. The holes can allow the paint to return into the can. The lid can then be reattached correctly and removed later. Without the drain holes, paint can accumulate in the lip, and act as an adhesive, preventing the lid from being easily removed later. Closing a lid with paint in the lip can also result in spill or the paint being expelled horizontally or vertically.

Current lid closer's can use cams, levers, screws, springs and handles that break, and are expensive to replace. Using a mallet can distort the lid, cause paint splatter, and does not always close the can completely, which can cause additional spills while shaking or during travel.

The above-described background relating to paint lids is merely intended to provide a contextual overview and is not intended to be exhaustive. Other context regarding the state of the art may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the purpose of this summary is to present some concepts related to some exemplary non-limiting embodiments in simplified form as a prelude to more detailed descriptions of the various embodiments that follow in the disclosure.

This disclosure comprises a method an apparatus for safely closing a paint can lid. Although this disclosure can be used to paint can lid, it should be noted that the lid closer can be used to close any lid and can combination that may not be associated with paint. The paint lid closer apparatus contained herein can comprise a base plate, a retainer, a shaft, a slidable impact grip, and finger guards. The paint lid closer apparatus can be made from plastic, metal, wood, plastic polymers, etc.

A bottom side of the base plate can be used to contact a paint lid situated on or within a paint can. The base plate can be formed in various shapes and sizes to facilitate closing of cans with various shapes and sizes. For instance, the base plate shape can include, but is not limited to: a square shape, a circular shape, a hexagonal shape, a pentagonal shape, an octagonal shape, etc. The sizes of each shape can also be varied so as to facilitate the closing of paint lids of differently sized cans. For instance, a circular can with an eight inch radius can use a smaller base plate than a circular can with a twelve inch radius. The base plate can be detachable from the paint lid closer so that various shaped and sized base plates can be attached to accommodate various shaped and sized cans. It should also be noted that the base plate can be weighted at various weights to aid in the transmission of pressure generated by the slideable impact member as described below

The base plate can also comprise splash guards to prevent paint from spilling while the paint lid closer is in use. The splash guards can also act as can guides to fit within the lip of the lid. It should be noted that although the splash gaurds can act as can guides in one embodiment, in another embodiment the splash gaurds and the can guides can be separate components. A retaining member can be located on a top side of the base plate. The retaining member can receive an impact member of the slidable impact grip.

The slidable impact grip can serve two functions: 1) to allow a user to maintain a firm grip on the paint lid closer, and 2) to generate the impact used to close the paint lids. The slidable impact member can be situated around the shaft, wherein the shaft is connected to the base plate at one end and comprises a hand guard (an upper hand guard and a lower hand guard) at a distal end. The slideable impact grip can be of varied diameters to accommodate users with various hand sizes. Furthermore, the slidable impact member can be weighted at various weights to increase or decrease the pressure transfer.

As the slidable impact member is transitioned from one point of the shaft to another, the user can generate pressure, which will be received by the base plate and transferred to the paint can lid to facilitate closing of the paint can lid. It should be noted that the shaft can also be of varied lengths to facilitate a corresponding pressure. For example, the longer the shaft is, the more opportunity a user has to generate a downward force as the user slides the slidable impact member to contact the base plate. The slidable impact member can comprise hand guards (an upper hand guard and a lower hand guard), which will prevent the user from injuring his/her hand. Therefore, the user can hold the distal end of the shaft with one hand between the hand guards as he/she holds the slidable impact grip with another hand and transitions the slidable impact grip back-and-forth to generate the pressure needed to close the paint can lid. It should be understood that in some embodiments, the paint lid closer may not comprise hand guards. It should also be noted that the orientation of the paint can closer can be changed to facilitate closing of a lid that is not normal to a horizontal surface. For instance, if the paint can and paint can lid are on an incline, the paint lid closer can be placed at a diagonal position to facilitate closing of the paint can lid.

Described herein are articles of manufacture and other embodiments or implementations that can facilitate closing of paint lids.

According to one embodiment, described herein is an apparatus for closing paint lids. The apparatus can comprise can comprise a base plate, a retainer, a shaft, a slidable impact grip, and finger guards.

According to another embodiment, described herein is a method for facilitating closing of a paint lid, wherein the method comprises contacting a bottom side of a base plate to a top side of a lid on a can, and gripping a stationary grip connected to a shaft. The method also comprises gripping a slidable impact grip, wherein the slidable impact grip surrounds the shaft, and sliding the slidable impact grip to transfer pressure from the base plate to the lid.

These and other embodiments or implementations are described in more detail below with reference to the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a side view of an example paint lid closer.

FIG. 2 illustrates a bottom view of an example paint lid closer.

FIG. 3 illustrates a perspective view of an example paint lid closer in relation to a paint can.

FIG. 4 illustrates an example system block diagram of a method for closing a paint can.

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As an overview, various embodiments presented herein to correct for the above-identified deficiencies and other drawbacks of current paint lid closure.

For simplicity of explanation, the methods are depicted and described as a series of acts. It is to be understood and appreciated that the various embodiments are not limited by the acts illustrated and/or by the order of acts. For example, acts can occur in various orders and/or concurrently, and with other acts not presented or described herein. Furthermore, not all illustrated acts may be required to implement the methods. In addition, the methods could alternatively be represented as a series of interrelated states via a state diagram or events.

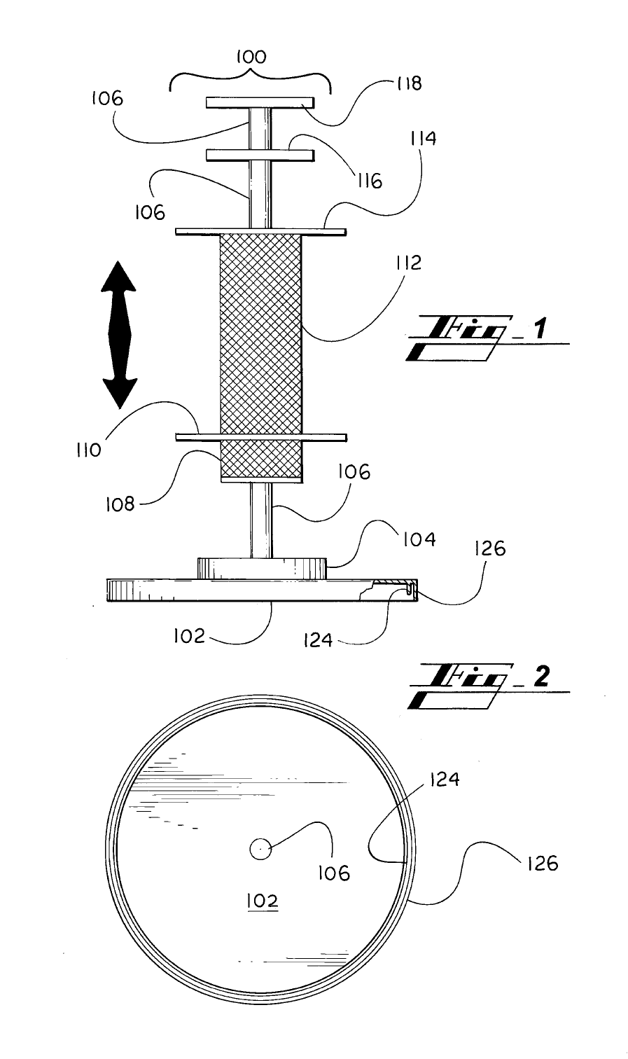

Referring now to FIG. 1, illustrated is a side view of an example paint lid closer 100. The paint lid closer 100 can comprise a base plate 102. The base plate 102 can comprise a retainer member 104 to receive an impact member 108. A slidable impact grip 112 can comprise the impact member 108. The slidable impact grip 112 can slide up and down a shaft 106 of the paint lid closer 100 to create pressure on the base plate 102. The base plate 102 can comprise a can guide 124 and a splash guard 126. The slidable impact grip can also comprise a lower hand guard 110 and an upper hand guard 114. The purpose of the hand guards 110, 114 is to prevent injury to a user's hand while the paint lid closer 100 is in use. At a distal end of the shaft 106, a stationary hand guard comprising an upper hand guard 118 and a lower hand guard 116 can be used to stabilize the paint lid closer 100 while in use.

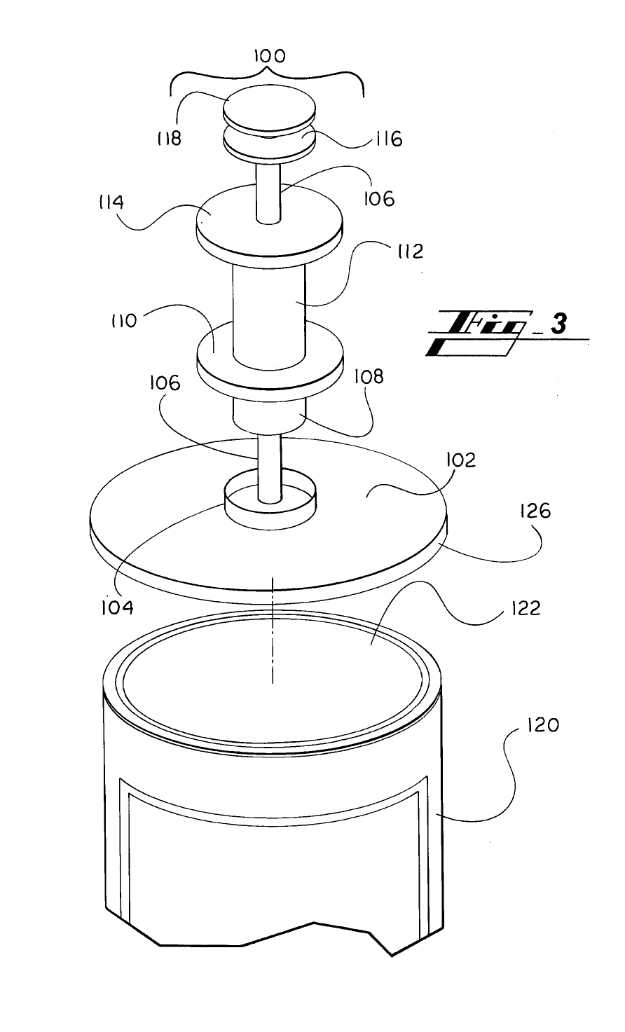

Referring now to FIG. 2, illustrated is a bottom view of an example paint lid closer. The base plate 102 can be detachable from the shaft 106 to facilitate the use of interchangeable base plates. The base plate 102 can be attached to the shaft by various means including, but not limited to: hook and pinion, screw, magnetic, pivot and lock, etc. The base plate 102 can comprise the can guide 124 and the splash guard 126. The base plate 104 can be different sizes and shapes including, but not limited to: a square shape, a circular shape, a hexagonal shape, a pentagonal shape, an octagonal shape, etc. The base plate can also be weighted at various weights to facilitate various levels of pressure applied to the paint lids during use of the paint lid closer.

Referring now to FIG. 3, illustrated is a perspective view of an example paint lid closer 100 in relation to a paint can 120. The paint lid closer 100 can comprise a base plate 102. The base plate 102 can comprise a retainer member 104 to receive the impact member 108. The slidable impact grip 112 can comprise the impact member 108. The slidable impact grip 112 can slide up and down the shaft 106 of the paint lid closer 100 to create pressure on the base plate 102. The slidable impact grip 112 can also comprise a lower hand guard 110 and an upper hand guard 114. The purpose of the hand guards 110, 114 is to prevent injury to a user's hand while the paint lid closer 100 is in use. At a distal end of the shaft 106, a stationary hand guard comprising an upper hand guard 118 and a lower hand guard 116 can be used to stabilize the paint lid closer 100 while in use.

While in use, the paint lid closer's 100 base plate can be in contact with a paint can lid 122 of the paint can 120. As the slidable impact member grip 112 is transitioned up and down along the shaft 106, it will generate pressure, which will be transferred from the base plate 102 to the paint can lid 122. The generated pressure can cause the paint can lid 122 to close the paint can 120 so that no air or liquid can pass between the paint can 120 and the paint can lid 122.

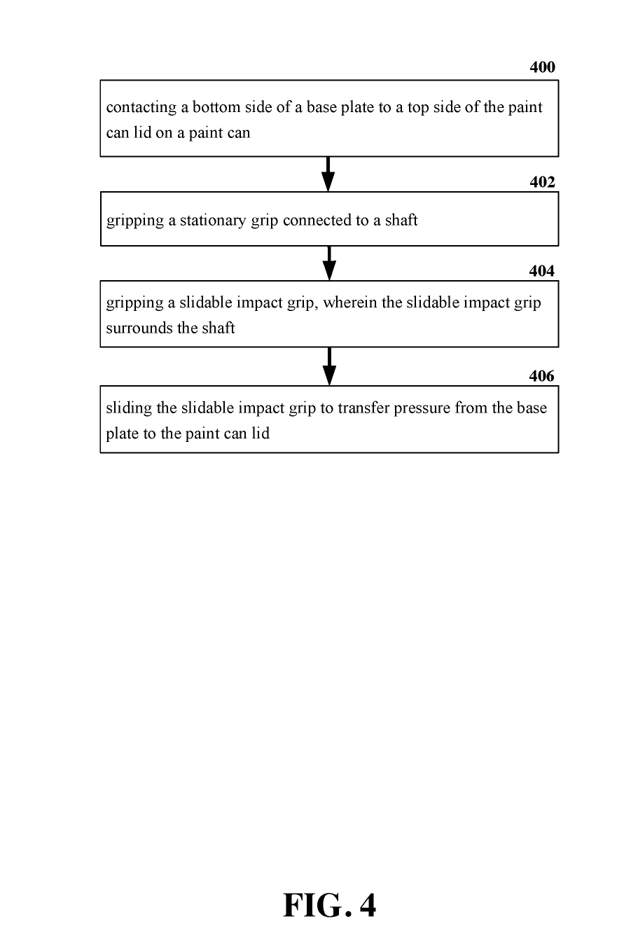

Referring now to FIG. 4, illustrated is an example system block diagram of a method for closing a paint lid. At element 400, a bottom side of a base plate can be contacted to a top side of a lid on a can. The base plate can be detachable from the shaft. The base plate can also be weighted and come in various shapes and sizes. At element 402, a stationary grip connected to a shaft can be gripped. The stationary grip can be used to stabilize the paint lid closer during use. The stationary grip can also comprise hand guards to prevent a user's hand from being pinched or injured by a slidable impact grip during use. The slidable impact grip can be gripped at element 404, wherein the slidable impact grip surrounds the shaft. Consequently, the slidable impact grip can be slid at element 406 to transfer pressure from the base plate to the lid. The more pressure the user applies to the slidable impact grip during use, the more pressure can be transferred to the paint lid via the base plate.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGs, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A lid closer apparatus, comprising:
a base plate;
a shaft;
a slidable impact grip; wherein the slidable impact grip is slidable on the shaft; and
a stationary grip.

2. The lid closer apparatus of claim 1, wherein the slidable impact grip comprises and impact member to impact the base plate.

3. The lid closer apparatus of claim 2, wherein the base plate comprises a retainer member attached to a top side of the base plate to receive the impact member.

4. The lid closer apparatus of claim 3, wherein the slidable impact grip comprises a first lower surface to protect a user's hand.

5. The lid closer apparatus of claim 4, wherein the slidable impact grip comprises a first upper surface to protect the user's hand.

6. The lid closer apparatus of claim 5, wherein the stationary grip comprises a second lower surface to protect the user's hand.

7. The lid closer apparatus of claim 6, wherein the stationary grip comprises a second upper surface to protect the user's hand.

8. The lid closer apparatus of claim 1, wherein the slidable impact grip comprises a rigid surface to faciliate user's grip of the slidable impact grip.

9. The lid closer apparatus of claim 1, wherein the base plate is of an octagonal shape.

10. The lid closer apparatus of claim 1, wherein the base plate is of a circular shape.

11. The lid closer apparatus of claim 1, wherein the base plate is of a triangular shape.

12. The lid closer apparatus of claim 1, wherein the base plate is of a hexagonal shape.

13. The lid closer apparatus of claim 1, wherein the base plate is of a triangular shape.

14. The lid closer apparatus of claim 1, wherein the base plate is of a square shape.

15. The lid closer apparatus of claim 1, wherein the base plate is of a pentagonal shape.

16. A method of closing a paint can lid, comprising:
contacting a bottom side of a base plate to a top side of the paint can lid on a paint can;
gripping a stationary grip connected to a shaft;
gripping a slidable impact grip, wherein the slidable impact grip surrounds the shaft; and
sliding the slidable impact grip to transfer pressure from the base plate to the paint can lid.

17. The method of claim 16, wherein the sliding the slidable impact grip comprises sliding the slidable impact grip in a lateral motion.

18. The method of claim 16, wherein the sliding the slidable impact grip comprises sliding the slidable impact grip in a vertical motion.

19. The method of claim 16, wherein the sliding the slidable impact grip comprises sliding the slidable impact grip in a horizontal motion.

20. The method of claim 16, wherein the sliding the slidable impact grip comprises sliding the slidable impact grip in a diagonal motion.
